(19) United States
(12) Patent Application Publication
(10) Pub. No.: US 2005/0191407 A1
(43) Pub. Date: Sep. 1, 2005

(54) Aerated confection puzzle

(76) Inventors: Emery Stephen Okos, Battle Creek, MI (US); Nicolas Amaya, Kalamazoo, MI (US); Dennis Harold Whitney, Battle Creek, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/054,878

(22) Filed: Feb. 10, 2005

Related U.S. Application Data
(60) Provisional application No. 60/543,175, filed on Feb. 10, 2004.

(51) Int. Cl. A23G 3/00

(52) U.S. Cl. 426/660

(57) ABSTRACT

A food product for providing play value to consumers is provided. The food product comprises a plurality of individual, edible food pieces having various complementary shapes such that the food pieces can be arranged as a puzzle to form an increasingly complex and recognizable structure. Each of the plurality of food pieces are an aerated confection comprising a sweetener and a structuring agent. The food product may be incorporated in a finished ready-to-eat (RTE) cereal.

### RELATED APPLICATIONS

This application claims the benefit of U.S. provisional patent application Ser. No. 60/543,175, filed Feb. 10, 2004, the advantages and disclosure of which are herein incorporated by reference.

### STATEMENT REGARDING FEDERALLY SPONSORED RESEARCH

None

### FIELD OF THE INVENTION

The present invention relates generally to a food product that provides play value to consumers. More specifically, the present invention relates to the food product comprising a plurality of individual food pieces that can be arranged by consumers as a puzzle to form increasingly complex and recognizable structures, especially food pieces that are confectionery based.

### BACKGROUND OF THE INVENTION

Using individual food pieces to create an edible puzzle is well known in the art. Edible puzzles provide added play value to the particular food product in which they are incorporated to increase consumption by consumers. A typical edible puzzle comprises a plurality of edible food pieces of different configurations, e.g., shapes and sizes, that are complementary to one another such that the food pieces can be arranged to form increasingly complex and recognizable structures.

One such puzzle is shown in U.S. patent application Publication No. 2003/0152668 to Griffin. Griffin discloses an edible puzzle that includes a plurality of individual food pieces that can be arranged by consumers to form increasingly complex and recognizable structures. For instance, in one embodiment, Griffin discloses food pieces in the shapes of a threaded bolt and a nut, with these food pieces being capable of actual assembly. The food pieces in Griffin are preferably confectionery based food pieces such as hard sugar confections.

U.S. Pat. No. 5,579,582 to Carlson discloses a cookie cutter than can be used to form a plurality of food pieces for use in an edible puzzle. Carlson suggests that the food pieces may be arranged to form a geometric shape, an animal or other caricature or representation.

Japanese Patent Application No's 9-038364 and 2002-223701 also disclose edible puzzles that include a plurality of individual food pieces that can be arranged by consumers to form increasingly complex and recognizable structures. Application No. 9-038364 discloses food pieces being arranged to form plates, pots, and dolls with the food pieces being confectionery pieces such as a rice cracker, a cookie, a biscuit, or a chocolate. Application No. 2002-223701 discloses food pieces being arranged to form an animal or other character with the food pieces being confectionery pieces.

Each of these prior art references disclose edible puzzles comprising individual food pieces that can be arranged to form increasingly complex and recognizable structures. These references also disclose the food pieces being confections. However, none of these prior art references disclose, teach, or suggest using aerated confections for this purpose.

### BRIEF SUMMARY OF THE INVENTION

The present invention provides a food product for providing play value to consumers. The food product comprises a plurality of individual, edible food pieces having various complementary configurations such that the food pieces can be arranged as a puzzle to form an increasingly complex and recognizable structure. Each of the plurality of food pieces are an aerated confection.

Previously, aerated confections were not considered for use in edible puzzles due to the difficulty in controlling the shapes and colors of such food pieces. However, processing of aerated confections has grown tremendously in the last few years with intricate designs of various shapes and colors being commercially introduced. Today, one of the primary advantages of using aerated confections is the versatility provided to such food pieces. Currently, several options are available for coloring and shaping the food pieces using conventional processing. In addition, aerated confections continue to be one of the most popular components of ready-to-eat cereals given their low moisture content and resistance to absorbing milk, and their interesting taste and appearance.

In one aspect of the present invention, each of the plurality of food pieces resembles a skeletal segment such as a skull, arm and leg bones, rib cage, and pelvic bone, and is multi-colored such that the food pieces can be arranged to form a skeleton-like creature.

In further aspects of the invention, each of the plurality of food pieces can be arranged to form an animal (mammal, bird, insect, fish, etc.), animated character, creature, inanimate object, word or phrase, and the like.

### BRIEF DESCRIPTION OF THE SEVERAL VIEWS OF THE DRAWINGS

Advantages of the present invention will be readily appreciated as the same becomes better understood by reference to the following detailed description when considered in connection with the accompanying drawings wherein:

FIG. 1 is a perspective view of an edible puzzle of the present invention comprising a plurality of food pieces arranged to form a skeleton-like creature;

FIG. 2 is a perspective view of an edible puzzle of the present invention comprising a plurality of food pieces arranged to form a skeleton-like creature;

FIG. 3 is a perspective view of an edible puzzle of the present invention comprising a plurality of food pieces arranged to form a biped;

FIG. 4 is a perspective view of an edible puzzle of the present invention comprising a plurality of food pieces arranged to form a canine;

FIG. 5 is a perspective view of an edible puzzle of the present invention comprising a plurality of food pieces arranged to form a spider;

FIG. 6 is a perspective view of an edible puzzle of the present invention comprising a plurality of food pieces arranged to form a bird;

FIG. 7 is a top view of an edible puzzle showing multiple complex and recognizable structures to be formed from individual food pieces;

FIG. 8 is a top view of an edible puzzle of the present invention comprising a plurality of food pieces having alphabetic characters arranged to form a word; and

FIG. 9 is a perspective view of an edible puzzle of the present invention comprising a plurality of food pieces arranged to form an animated character.

### DETAILED DESCRIPTION OF THE INVENTION

Referring to the Figures, wherein like numerals indicate like or corresponding parts throughout the several views, a food product for providing play value to consumers is generally indicated at 10. The food product is in the form of an edible puzzle 10 comprising a plurality of individual and edible food pieces 12, i.e., puzzle pieces, of various configurations, e.g., shapes and sizes. The configurations are complementary to one another such that the food pieces 12 can be arranged to form increasingly complex and recognizable structures, e.g., animals (mammal, bird, insect, fish, etc.), animated characters, creatures, inanimate objects, words or phrases, and the like. The term puzzle as used herein refers to the food pieces 12 and their capacity to be arranged to form increasingly complex and recognizable structures, i.e., the puzzle pieces 12 are designed for providing play value by testing ingenuity. In many of the embodiments set forth below, the puzzle pieces 12 are further capable of being arranged in multiple ways to form multiple increasingly complex and recognizable structures, i.e., the edible puzzles have multiple solutions.

Each of the plurality of food pieces 12 are preferably aerated, form-stable confections. More preferably, each of the food pieces 12 are marshmallow bits, which are well known for use in ready-to-eat cereals. The food pieces 12 can be formed using any conventional aerated confection formulations and/or processing techniques. Examples of formulations and processing techniques that may be employed in manufacturing the food pieces 12 are disclosed in U.S. Pat. Nos. 4,785,551; 4,925,380; 6,180,158; 6,197,355; 6,432,460; and 6,436,455, all of which are herein incorporated by reference. The most preferred formulation and processing of the food pieces 12 are disclosed in U.S. patent application Publication No. 2004/0109933 to Roy et al., herein incorporated by reference.

In general, each of the food pieces 12 has a density in the range of from 0.1 to 1.0 grams per cubic centimeter, more preferably from 0.25 to 0.39 grams per cubic centimeter. The food pieces 12 are preferably dried to a moisture level of from 1 to 30 percent, generally less than 16 percent, and most preferably less than 5 percent. In view of the low water content, the food pieces 12 typically have a firm texture and are resistant to absorbing liquids, e.g., milk. It is contemplated that either inflexible hard pieces of dried marshmallow bits or semi-flexible pieces of dried marshmallow bits will be used for the food pieces 12.

The food pieces 12 comprise from about 50 to 98 weight percent of sweetener, more preferably from about 50 to 80 weight percent, from about 0.5 to 30 weight percent of a structuring or gelling agent, more preferably from 1.0 to 2.5 weight percent, up to about 5 weight percent of flavoring agents, and up to about 15 weight percent of other ingredients such as coloring agents, dairy products, fats, etc., all based on a total weight of the finished food pieces 12.

The sweetener can be in the form of sucrose, dextrose, fructose, crystalline fructose, lactose, malt syrup, malt syrup solids, rice syrup solids, rice syrup, sorghum syrup, invert sugar, refiners syrup, corn syrup, corn syrup solids, maltose, high fructose corn syrup, honey, molasses, sugar alcohols, maltodextrin, or combinations thereof. It should be appreciated that a “no sugar added” food product could also be formulated using sorbitol and other sugar alcohols. The structuring or gelling agent may include a hydrocolloid ingredient such as pectin, gelatin, modified starches, albumen, gums, or combinations thereof. The flavoring agents may include fruit juices, fruit purees, honey nectars, concentrated fruit juices, fruit flavors, or combinations thereof.

Referring to FIGS. 1-9, several embodiments of the edible puzzle are shown. The edible puzzles provide consumers with added play value by allowing the consumers to form the increasingly complex and recognizable structures by manually manipulating the food pieces 12 until the complementary-shaped food pieces 12 fit together. Each of the food pieces 12 preferably abuts at least one adjacent food piece 12 to form the increasingly complex and recognizable structures. The food pieces 12 are preferably bite-sized such that they can be easily manipulated and consumed by the consumer.

The food pieces 12 find particular suitability for use as an appealing added component of ready-to-eat (RTE) breakfast cereals, especially sugar coated RTE cereals. In one embodiment, a finished RTE cereal can comprise from about 65 to 99 weight percent of a conventional dried cereal (such as flakes, shreds, biscuits, or puffs formed from a cooked cereal grain or dough of oats, wheat, corn, barley, rice or mixtures thereof) and from about 1 to 35 weight percent of the food pieces 12, more preferably from about 15 to 25 weight percent of the food pieces 12. In this manner, consumers, e.g., children, can discover the food pieces 12 in the RTE cereal that are necessary to form the increasingly complex and recognizable structures. In addition, suggested structures can be shown on boxes containing the RTE cereal. In one embodiment, the suggested structure to be formed is illustrated on the cereal box with only outlines representing the appropriate shape and location of the food pieces 12. This requires the children to hunt for and gather the necessary food pieces 12, and by trial and error find the appropriate food pieces 12 to complete the structure. This adds substantial play value to the RTE cereal. In still other embodiments, the food pieces 12 can be provided in separate packaging, or can be used as toppings for desserts such as ice cream or yogurt. The food pieces 12 could also be incorporated in various other food items.

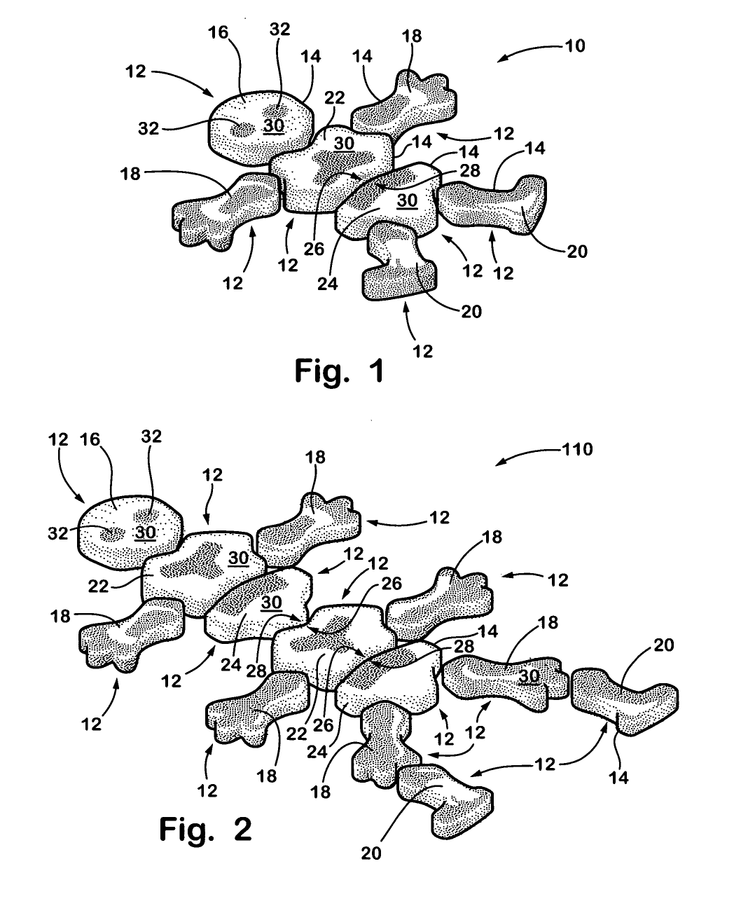

With reference to FIGS. 1 and 2, first and second edible puzzles 10, 110 of the present invention are shown. In these edible puzzles 10, 110, the food pieces 12 resemble skeletal segments such as a skull 16, arm bones 18, leg bones 20, a rib cage 22, and a pelvic bone 24. As a result, the food pieces 12 can be arranged to form a skeleton-like creature. Each of the food pieces 12 includes a periphery 14 that defines an outline of the shape of the food piece 12. The periphery 14 can include any regular or irregular shapes. Here, the peripheries 14 of each of the food pieces 12 define at least one of a male periphery 26 or female periphery 28 portion such that the food pieces 12 are complementary to one another to facilitate their arrangement into the skeleton-like creature. In one embodiment, the shape of the food pieces 14 can be provided by extruding through similarly shaped dies, as discussed in the processing patents incorporated herein by reference. Each of the food pieces 12 assumes a similar thickness such that the food pieces 12 appropriately line-up when placed on a planar surface for arrangement. As shown in FIGS. 1 and 2, the food pieces 12 can be arranged to form multiple creatures. This is one example of an embodiment in which multiple solutions are possible.

Each of the food pieces 12 has opposed major surfaces 30 bounded by their peripheries 14 (only the top major surfaces 30 are shown in the figures). Those skilled in the art of manufacturing aerated confections by extrusion will appreciate that both major surfaces 30 of each food piece 12 include similar features, since the food pieces 12 are usually cut from the same extrudate rope. Still referring to FIGS. 1 and 2, one of the food pieces 12 includes a pair of eyes 32 represented by first and second spaced circular portions on the major surface 30 with the circular portions having a color that is different than that of the remaining portion of the food piece. In addition, the food pieces 12 forming the arm 18 and leg 20 bones of the skeleton-like creature include swirls of color. Finally, the food pieces 12 forming the rib cage 22 and pelvic bone 24 of the skeleton-like creature have a first color at least partially disposed about their periphery 14 and surrounding or abutting a second color.

Multi-colored food pieces 12, i.e., food pieces 12 having two or more different colors, can be formed by a variety of processes including co-extrusion. In some embodiments, the food pieces 12 include multiple colors in unequal proportions. It some embodiments, the colors are in equal proportions. It will be appreciated that the variously colored regions may extend throughout the entire food piece 12 or may be a simple colored coating placed on the major surfaces 30 of the food pieces 12. The food pieces 12 can also have the same color throughout, or different food pieces 12 can have different colors. The term color includes any color (including black and white), hue, shade, or variation thereof which may be provided by the addition of any natural or synthetic coloring agents, or which is naturally provided by mixing the ingredients of the food pieces 12 together. With respect to flavor, the food pieces 12 can have any combination of flavors. Each food piece 12 can have a different flavor than other food pieces 12, each food piece 12 can have multiple flavors, or each of the food pieces 12 can have the same flavor.

The food pieces 12 preferably have a uniform texture and composition throughout. By uniform composition, it is understood that the colored portions of the food pieces 12 will contain similar levels of moisture, sweetener, and structuring agent. Also, the texture, density, and foam cell size of the colored portions will be approximately equal. In other embodiments, the colored portions can have dissimilar compositions.

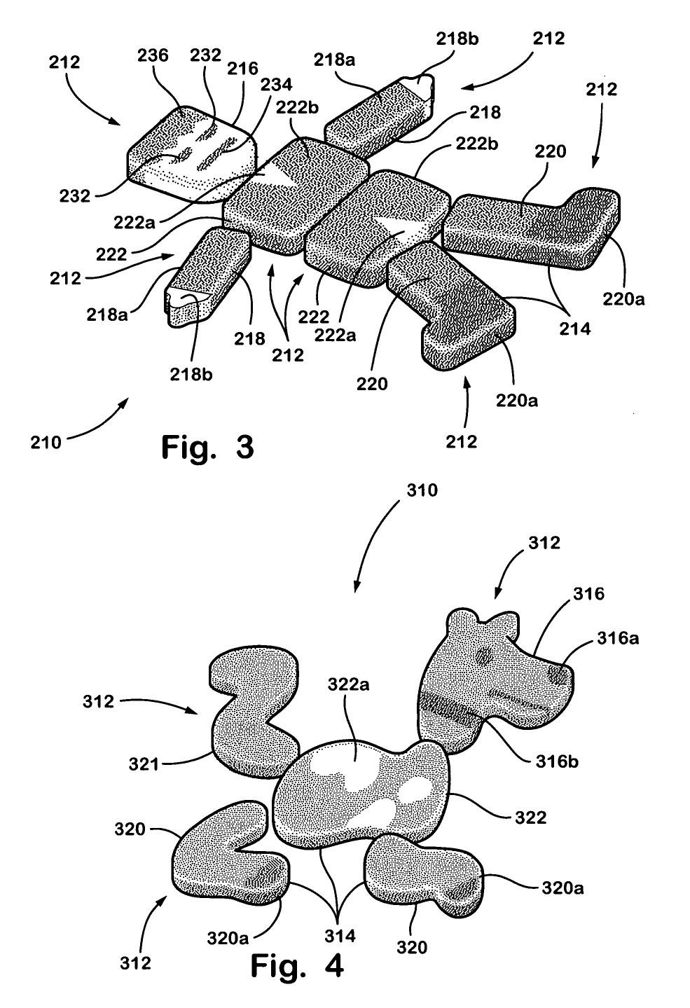

Referring to FIG. 3, a third edible puzzle 210 is shown. Here, the food pieces 212 are arranged to resemble a biped such as Frankenstein. One of the food pieces 212 is in the shape of a head 216 having a pair of eyes 232, a mouth 234 that is represented by a generally rectangular shape positioned below the eyes 232, and hair 236 that is represented by a saw tooth pattern. These features may all be differently colored, separate from the remaining portion of the head piece 216, or these features could be a uniform color such as black, while the remaining portion of the head piece 216, i.e., the face, is another color.

Arranged below the head are two food pieces 212 that abut one another to form torso pieces 222 of the biped. In viewing the torso pieces 222, a triangular-shaped section 222a is set against a background 222b of a different color to give the appearance of clothing worn by the biped. Abutting the upper torso piece 222 are two food pieces 212 in the shape of arms 218 with sleeve 218a and hand 218b portions of different colors. The sleeve portion 218a is generally rectangular with an irregularly shaped hand portion 218b. Abutting the lower torso piece 222 are the last two food pieces 212 forming this edible puzzle. These food pieces 212 are in the shape of legs 220 with shoes or boots 220a. Each of the leg pieces 220 includes a first generally rectangular portion having a first color and a second generally rectangular portion located below the first generally rectangular portion and having a second color different than the first color. As previously mentioned, given the characteristics of extrusion, each separately colored portion extends entirely through the food pieces 212.

FIGS. 4-6 illustrate additional edible puzzles of the present invention in which the food pieces resemble parts of a creature such as an animal or animated character. In each of these embodiments, the plurality of food pieces include at least one food piece resembling a head, at least one food piece resembling a torso, and at least one food piece resembling an appendage. The appendages shown include arms, legs, feet, wings, and tails.

Referring to FIG. 4, the edible puzzle 310 includes a plurality of food pieces 312 that are arranged to resemble a canine. Here, the head piece 316 is in the shape of a canine's head 316 complete with a nose 316a and a collar 316b. The torso piece 322 is in the shape of a canine body 322 that includes spots 322a. The appendage pieces 320, 321 are in the shape of canine legs 320 that include colored shadings 320a to represent paws 320a, and a canine tail 321. The head piece 316, leg pieces 320, and tail piece 321 all abut the torso piece 322 about the periphery 314 of the torso piece when properly arranged.

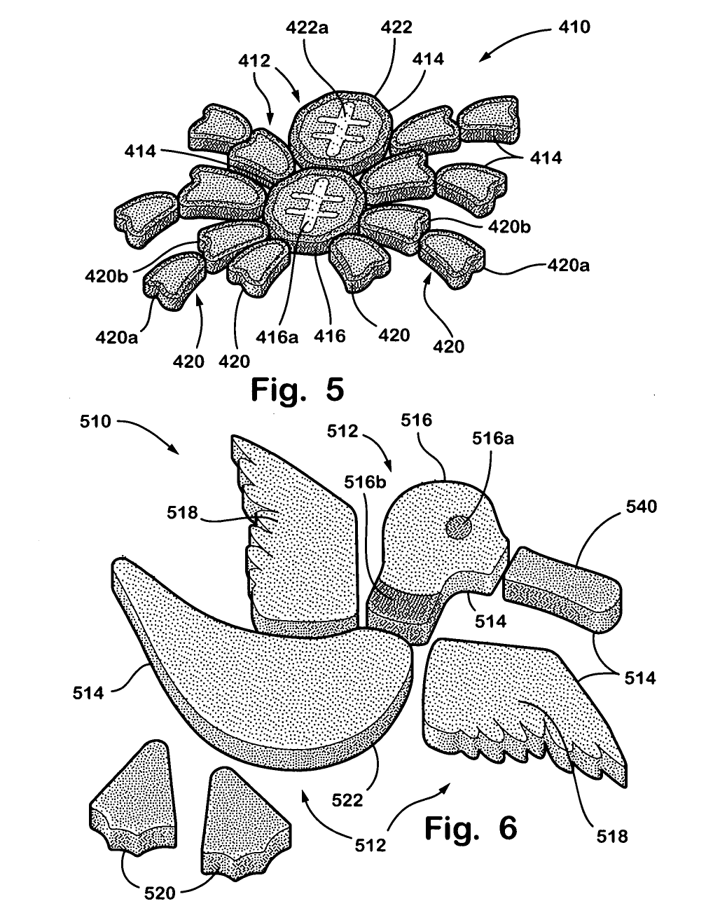

Referring to FIG. 5, the edible puzzle 410 includes a plurality of food pieces 412 that are arranged to resemble a spider. The head piece 416 is in the shape of a spider's head 416 complete with differently colored markings 416a. The torso piece 422 is in the shape of a spider's abdomen also complete with colored markings 422a. The appendage pieces are in the shape of spider legs 420 with a portion of the legs 420 being formed with two abutting leg sections 420a, 420b. The leg pieces 420 can be arranged about the head piece 416 or the torso piece 422, or both. As shown, each of the food pieces 412 may include an outline about the periphery 414 having a first color and an interior having a second color different than the first color and in dissimilar proportions.

Referring to FIG. 6, the edible puzzle 510 includes a plurality of food pieces 512 that are arranged to resemble a bird, such as a duck. The head piece 516 is in the shape of a bird's head 516 complete with separately colored eye 516a and neck 516b portions. The torso piece 522 is in the shape of a bird's torso 522. The appendage pieces are in the shape of two wings 518, two feet 520, and a beak 540. The head piece 516, wing pieces 518, and feet pieces 520 each abut the torso piece 522. The beak piece 540 abuts the head piece 516.

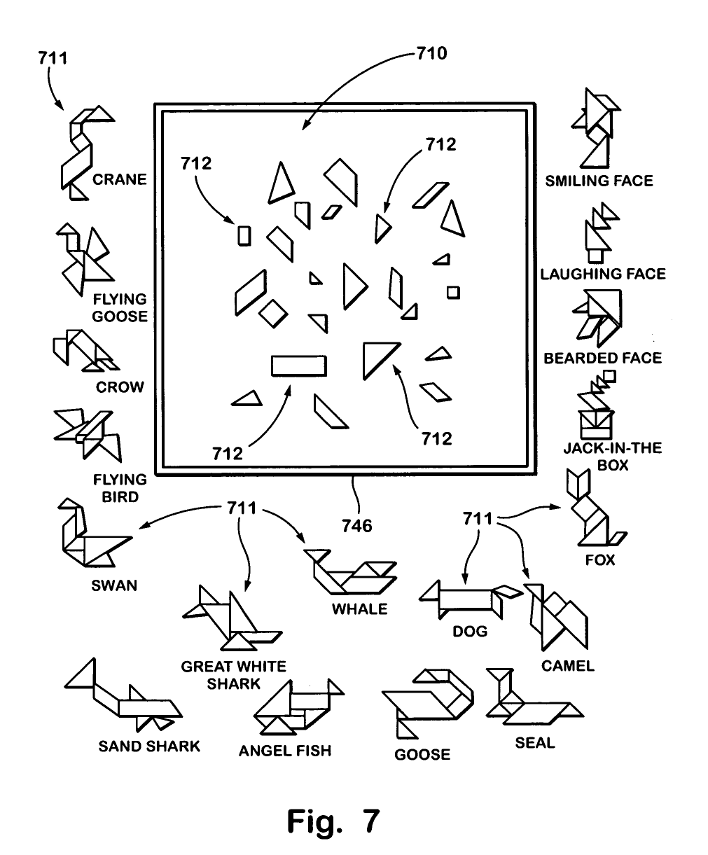

Referring to FIG. 7, another edible puzzle 710 of the present invention is shown. Here, the food pieces 712 are capable of forming multiple complex and recognizable structures 711 such as a crane, flying goose, crow, flying bird, swan, sand shark, great white shark, whale, angel fish, goose, seal, camel, dog, fox, jack-in-the-box, bearded face, laughing face, and smiling face shapes, respectively. In other words, this edible puzzle 710 has multiple solutions. A blank board 746 is illustrated for supporting the food pieces 712 to be arranged. The food pieces 712 preferably assume simple geometric shapes to form these increasingly complex and recognizable structures. Most preferably, the food pieces 712 are triangular and quadrilateral shaped.

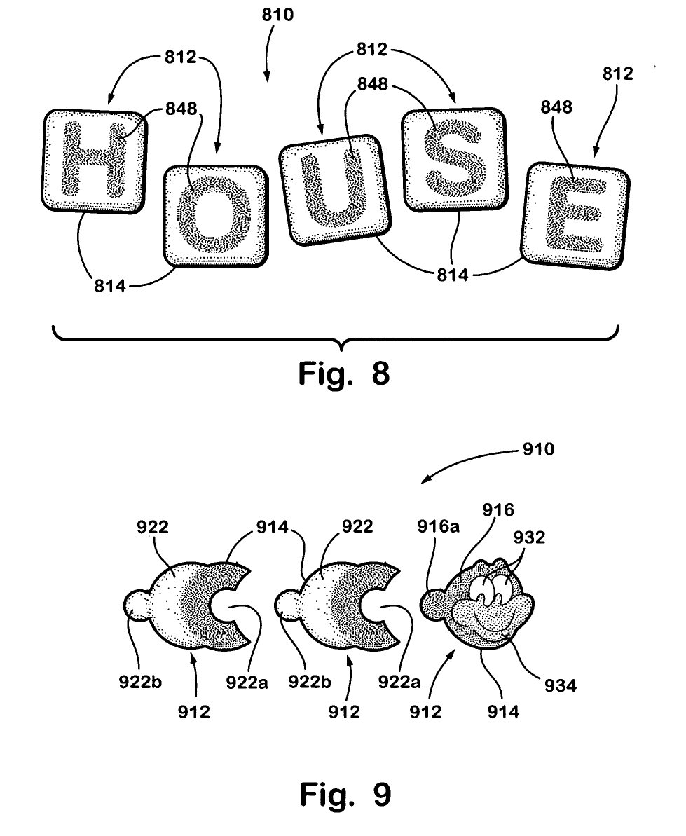

Referring to FIG. 8, yet another edible puzzle 810 of the present invention is shown. Here, each of the food pieces 812 have a box-like shape with rectangular peripheries 814. The food pieces 812 include varying colors, each with an alphabetic character 848, e.g., capital letters, outlined in a different color, and spaced from the peripheries 814. As a result, the plurality of food pieces 812 can be arranged to form recognizable words or phrases. Of course, numerals or other symbols could replace all or a portion of the alphabetic characters 848.

Referring to FIG. 9, a still further edible puzzle 910 of the present invention is shown. Here, only two basic food pieces 916, 922 are provided to resemble parts of an animated character, in this case a worm. One of the food pieces 912, the body piece 922, includes a socket 922a at one end and a projection 922b at the opposite end that mates with the sockets 922a of adjacent body pieces 922 such that multiple body pieces 922 can be joined together in an end-to-end manner to form longer worm bodies. The other food piece 912, the head piece 916, includes a projection 916a that can be inserted into the socket 922a of the body piece 922 to form the animated character, i.e., the worm. The head piece 916 may include differently colored eyes 932 and mouth 934. Each food piece 912 in this embodiment may have a different color or flavor and if multiple body pieces 922 and head pieces 916 are provided in a package (not shown), there may be multiple combinations of colors or flavors that can be assembled into short or long worms to form the animated character. In this manner, increasingly complex and recognizable structures can be formed by physically interconnecting the food pieces 912.

It should be appreciated that the increasingly complex and recognizable structures formed are not limited to those shown. Other structures may be contemplated that have not been specifically set forth herein. Obviously, many modifications and variations of the present invention are possible in light of the above teachings. The invention may be practiced otherwise than as specifically described within the scope of the appended claims.

1. A food product for providing play value to consumers, comprising:
a plurality of individual food pieces with at least one of said food pieces having a first configuration and at least one of said food pieces having a second configuration different than said first configuration and complementary to said first configuration,
said plurality of food pieces being edible and arrangeable as a puzzle to form an increasingly complex and recognizable structure, and
each of said plurality of food pieces being an aerated confection.

2. A food product as set forth in claim 1 wherein each of said plurality of food pieces comprises from about 50 to 98 weight percent sweetener, and from about 0.5 to 30 weight percent structuring agent, based on a total weight of said food pieces.

3. A food product as set forth in claim 1 wherein at least one of said plurality of food pieces includes a first color and a second color different than said first color to form a multi-colored food piece.

4. A food product as set forth in claim 3 wherein said first and second colors of said multi-colored food piece are swirled together.

5. A food product as set forth in claim 3 wherein said multi-colored food piece has a periphery and said first color is disposed about said periphery and surrounds said second color.

6. A food product as set forth in claim 1 wherein each of said plurality of food pieces resemble skeletal segments of a creature.

7. A food product as set forth in claim 6 wherein said plurality of food pieces include at least one food piece resembling a skull, at least one food piece resembling an arm bone, at least one food piece resembling a leg bone, at least one food piece resembling a rib cage, and at least one food piece resembling a pelvic bone, such that said plurality of food pieces can be assembled to form a skeleton-like creature.

8. A food product as set forth in claim 1 wherein said plurality of food pieces include at least one food piece resembling a head, at least one food piece resembling a torso, and at least one food piece resembling an appendage.

9. A food product as set forth in claim 8 wherein said appendage is at least one of a leg, an arm, a wing, or a tail.

10. A food product as set forth in claim 1 wherein each of said plurality of food pieces include an alphabetic character such that said plurality of food pieces can be arranged to form words.

11. A food product as set forth in claim 1 wherein at least one of said plurality of food pieces have a male periphery portion and at least one of said plurality of food pieces have a female periphery portion for abutting said male periphery portion.

12. A food product as set forth in claim 1 wherein a first of said plurality of food pieces has a projection and a second of said plurality of food pieces has a socket sized for mating with said projection such that said first and second food pieces can be interconnected to form said increasingly complex and recognizable structure.

13. A food product as set forth in claim 12 wherein a third of said plurality of food pieces includes both a projection and a socket and said second food piece includes a projection for mating with said socket of said third food piece such that said first, second, and third food pieces can be interconnected to form said increasingly complex and recognizable structure.

14. A food product as set forth in claim 1 including dried cereal pieces such that said food product is a ready-to-eat cereal with said dried cereal pieces and said food pieces.

15. A food product as set forth in claim 14 wherein said dried cereal pieces comprise from 65 to 99 weight percent of said food product and said food pieces are further defined as marshmallow bits comprising from 1 to 35 weight percent of said food product, based on a total weight of said food product.

16. A food product as set forth in claim 1 wherein said food pieces can be arranged as a puzzle to form multiple increasingly complex and recognizable structures.
